(19) United States
(12) Patent Application Publication
(10) Pub. No.: US 2017/0006584 A1
(43) Pub. Date: Jan. 5, 2017

(54) METHOD AND DEVICE OF RESOURCE ALLOCATION IN PHYSICAL DOWNLINK CONTROL CHANNELS

(71) Applicant: SAMSUNG ELECTRONICS CO., LTD., Suwon-si (KR)

(72) Inventors: Junwei REN, Beijing (CN); Wei LIU, Beijing (CN); Yingyang LI, Beijing (CN); Zhewel SHI, Beijing (CN)

(21) Appl. No.: 15/104,067

(22) PCT Filed: Dec. 8, 2014
(86) PCT No.: PCT/KR2014/012012

§ 371 Date: Jun. 13, 2016

(30) Foreign Application Priority Data
Dec. 11, 2013 (CN) 201310675091.4

(51) Int. Cl. H04W 72/04; H04L 1/18; H04W 72/08; H04L 5/00

(52) U.S. Cl. CPC H04W 72/042; H04L 5/0053; H04L 1/1864; H04W 72/085; H04W 88/02

(57) ABSTRACT

The present application discloses a method and a device of resource allocation in Physical Downlink Control Channels (PDCCHs). The present application successfully improves the reliability of the transmission in PDCCH.

### BACKGROUND OF THE INVENTION

1. Field of the Invention

The present application relates to wireless communication technology, and particularly to a method and a device of resource allocation in Physical Downlink Control Channels.

2. Description of the Related Art

A downlink physical channel of LTE (Long Term Evolution) includes a traffic channel and a control channel. Herein the traffic channel is a Physical Downlink Shared Channel (hereinafter referred to as PDSCH) adapted for transporting downlink data and system broadcast information. The control channel includes three kinds of channels:

a Physical Downlink Control Channel (hereinafter referred to as PDCCH) adapted for indicating information about modulation and demodulation, resource allocation, precoding and etc. necessary for a LTE User Equipment (hereinafter referred to as UE) to demodulate the PDSCH;

a Physical Hybrid-ARQ Indicator Channel (hereinafter referred to as PHICH) adapted for indicating whether the PDSCH has been correctly demodulated;

a Physical Control Format Indicator Channel (hereinafter referred to as PCFICH) adapted for indicating a position of an Orthogonal Frequency Division Multiplexing (hereinafter referred to as OFDM) sign used by PDCCH.

As shown above, only when the UE has correctly demodulated the PDCCH, can it correctly demodulate the PDSCH. Therefore, the PDCCH is the key of LTE for system resource allocation and control information scheduling, and the reliability of transmission in the PDCCH directly influences the LTE system performance.

At present, there are several methods in existing technology to improve the reliability of transmission in the PDCCH as follows:

Method 1: Adaptiveness of PDCCH Format

The PDCCH format, that is, a Control Channel Element (hereinafter referred to as CCE) aggregation level, includes four types which contain 1 CCE, 2 CCEs, 4 CCEs and 8 CCEs respectively. The higher the CCE aggregation level of a PDCCH is, the lower a coding rate of the PDCCH is and the higher a reliability demodulation of the PDCCH is. Therefore, a LTE evolved Node B (hereinafter referred to as eNB) may adaptively select a suitable PDCCH format in accordance with conditions of a radio channel to improve the reliability of transmission in PDCCH.

Method 2: Power Control of the PDCCH

According to a quality of downlink signals such as a Channel Quality Indicator (hereinafter referred to as CQI) and a Hybrid Adaptive Re-transmission Request (HARQ) Discontinuous Transmission (DTX) feedbacked by the UE, the eNB may adjust transmitting power of the PDCCH dynamically. If the UE feedbacks low CQI but many HARQ DTXs, the eNB will improve the transmitting power of the PDCCH to guarantee the reliability of the transmission in PDCCH; conversely, if the UE feedbacks high CQI but fewer HARQ DTXs, the eNB will reduce the transmitting power of the PDCCH to save power resources and reduce interference to neighboring cells, so the reliability of the transmission in PDCCH is further guaranteed.

Method 3: Reduction of PDCCH Channel Load

Reduce user numbers scheduled in the same subframe at the same time, and guarantee that a load of control channel will not exceed a preset percentage threshold. Once all cells have adopted the scheme, Resource Elements (hereinafter referred to as RE) occupied by PDCCHs scheduled among cells for users will significantly have fewer chances to interfere with each other, and the reliability of transmission in PDCCH is further guaranteed.

### SUMMARY OF THE INVENTION

However, there are problems with the three methods above as follows:

(1) Method 1 and Method 2 only consider a quality of the PDCCH in the current cell, but not as well as a resource allocation of the PDCCH in a neighboring cell. If the neighboring cell allocates the PDCCH with the same frequency to an UE in an edge area of the neighboring cell and improves the transmitting power through power control, PDCCHs of the UEs will interfere with each other, thus the reliability of transmission in PDCCH is not guaranteed and power resources of PDCCHs are wasted.

(2) Method 3 just considers an occupation of PDCCH resources in the cell, but not as well as an occupation of PDCCH resources in a neighboring cell. Therefore, it doesn't completely eliminate mutual interference of PDCCHs among cells, but just reduces a possibility of mutual interference of PDCCHs in neighboring cells, meanwhile it limits the number of users scheduled in the same subframe and decreases a network capacity, and the reliability of the transmission in PDCCH is not guaranteed.

### TECHNICAL SOLUTION

To solve the problem that the reliability of the transmission in PDCCH is not improved in existing technology, the present application provides a method and device of resource allocation in PDCCHs.

The technical scheme of the present application is made as follows:

According to one aspect of the present application, a method of resource allocation in PDCCHs is provided and includes:

determining relative positions of UEs in at least two neighboring cells;

determining for each UE a CCE aggregation level of a PDCCH of the UE, and calculating a UE-specific search space of the PDCCH in each subframe according to the CCE aggregation level of the PDCCH of the UE;

on condition that at least two UEs are in an overlapping area between neighboring cells and the at least two UEs belong to different neighboring cells, selecting for each UE of the at least two UEs a group of CCEs without overlapping in frequency domain with a group of CCEs that have been allocated to a PDCCH for other UE of the at least two UEs in the UE-specific search space of the PDCCH in each subframe of the current UE according to the CCE aggregation level of PDCCH for the current UE, and allocating the group of CCEs to a PDCCH of the current UE.

According to another aspect of the present application, a device of resource allocation in PDCCHs is provided and includes:

a position determining module, for determining relative positions of UEs in at least two neighboring cells;

a calculating module, for determining for each UE a CCE aggregation level of a PDCCH of the UE, and calculating an UE-specific search space of the PDCCH in each subframe according to the CCE aggregation level of the PDCCH of the UE;

a selecting and allocating module, for when the position determining module determines that at least two UEs are in an overlapping area in neighboring cells and the at least two UEs belong to different neighboring cells, selecting for each UE of the at least two UEs a group of CCEs without overlapping in frequency domain with a group of CCEs that have been allocated to a PDCCH for other UE of the at least two UEs in the UE-specific search space of the PDCCH in each subframe of the current UE according to the CCE aggregation level of the PDCCH of the current UE, and allocating the group of CCEs to a PDCCH of the current UE.

To be noted, the technical scheme above of the present application can make PDCCHs of several UEs in the overlapping area of neighboring cells have different frequency domain and will not have same frequency interference with each other; further, enhance respective transmitting power of PDCCHs for the UEs through power control; therefore, improve the reliability of transmission in PDCCH.

### BRIEF DESCRIPTION OF THE DRAWINGS

FIG. 1 is a diagram illustrating a mapping relationship between a REG and a RE;

FIG. 2 is a diagram illustrating possible beginning positions of different CCE aggregation levels;

FIG. 3 is a diagram illustrating a processing procedure of a physical layer in a PDCCH;

FIG. 4 is a flow diagram illustrating a method of resource allocation in PDCCHs according to Embodiment 1 of the present application;

FIG. 5 is a diagram illustrating a mapping relationship of CCEs overlapping in frequency domain among cells according to in Embodiment 1 of the present application;

FIG. 6 is another flow diagram illustrating a method of resource allocation in PDCCHs according to Embodiment 1 of the present application;

FIG. 7 is a structural diagram illustrating a device of resource allocation in PDCCHs according to Embodiment 2 of the present application;

FIG. 8 is a diagram illustrating a practical application scenario according to Embodiment 4 of the present application.

### DETAILED DESCRIPTION OF EXEMPLARY EMBODIMENTS

To solve the problem that the reliability of transmission in PDCCH is not improved in existing technology, following embodiments of the present application provide a method of resource allocation in PDCCHs as well as a device to apply the method, so PDCCH scrambled by SI-RNTI (System Information Radio Network temporary Identifier), P-RNTI (Paging Radio Network temporary Identifier) and RA-RNTI (Random Access Radio Network temporary Identifier) may be coordinately allocated. Once frequency domain of PDCCHs have been coordinately allocated, PDCCHs in neighboring cells will not mutually overlap in frequency domain, therefore no same frequency interference exists and the reliability of a broadcast channel, a paging channel and a random access channel may be correspondingly enhanced.

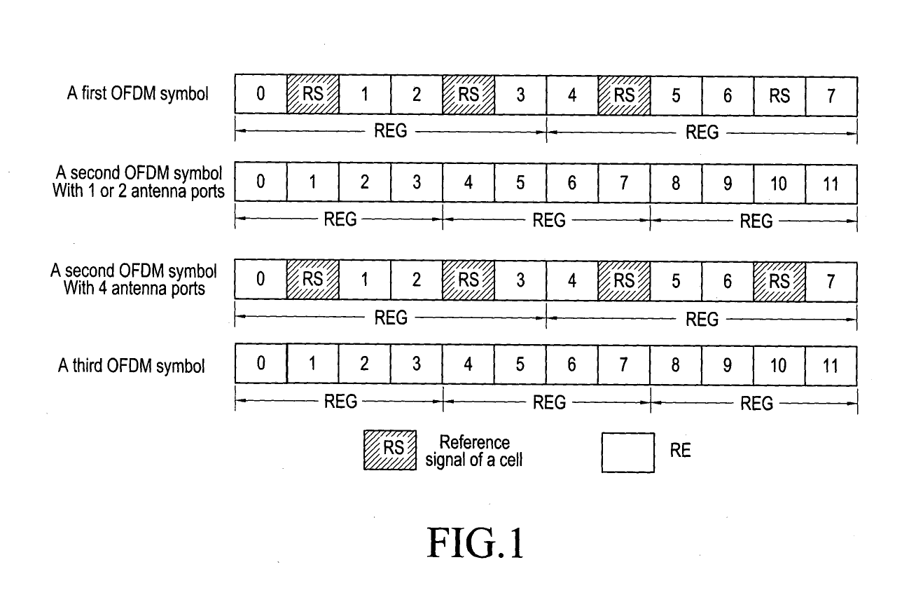

A basic unit of a LTE PDCCH is Resource Element Group (hereinafter referred to as REG) and a REG includes 4 successive Resource Elements (hereinafter referred to as RE). A mapping relationship between a REG and a RE in a Resource Block (hereinafter referred to as RB) is shown in FIG. 1. As shown in FIG. 1, within a RB a first OFDM symbol includes 2 REGs, a second OFDM symbol with one or two antenna ports includes 3 REGs and a third OFDM symbol includes 3 REGs; and a REG includes 4 REs.

A resource occupation of a control channel in a LTE downlink physical channel is as follows:

1, PCFICH

A PCFICH is located in the first OFDM symbol in every subframe and occupies 4 REGs in total. For frequency diversity, the 4 REGs carried PCFICHs equidistribute in frequency domain according to Formula (1):

k₁=[(N_{sc}^{RB}/2)·(N_{ID}^{cell} mod 2NR_{RB}^{DL})] mod N_{RB}^{DL}N_{sc}^{RB}

k₂=[k₁+└N_{RB}^{DL}/2┘·N_{sc}^{RB}/2] mod NR_{RB}^{DL}N_{sc}^{RB}

k₃=[k₁+└2N_{RB}^{DL}/2┘·N_{sc}^{RB}/2] mod NR_{RB}^{DL}N_{sc}^{RB}

k₄=[k₁+└3N_{RB}^{DL}/2┘·N_{sc}^{RB}/2] mod NR_{RB}^{DL}N_{sc}^{RB} (1)

Herein, k₁ represents a serial number of the first subcarrier for the ith REG occupied by the PCFICH, i=1, 2, 3, 4; N_{sc}^{RB} represents a number of subcarriers in a RB, N_{RB}^{DL} represents a total number of RBs within a system bandwidth, N_{ID}^{cell} represents a cell identifier.

2, PHICH

A PHICH occupies 3N_{PHICH}^{group} REG resources, and N_{PHICH}^{group} is determined as follows:

For a FDD (Frequency Division Duplexing) system, uplink subframes and downlink subframes exist at the same time, so a number of PHICH groups in a subframe is fixed and is specifically determined according to Formula (2):

$${N}_{PHICH}^{group} = \{ \begin{matrix}⌈ {N}_{g} ( {N}_{RB}^{DL} / 8 ) ⌉ & for normal cyclic prefix \\ 2 \cdot ⌈ {N}_{g} ( {N}_{RB}^{DL} / 8 ) ⌉ & for extended cyclic prefix\end{matrix} \qquad ( 2 )$$

Herein, N_{RB}^{DL} represents a total number of RBs within a system bandwidth, N_{g} is notified in PBCH, N_{g}ε(1/6, 1/2, 1, 2).

For a TDD (Time Division Duplexing) system, because an asymmetry between uplink subframes and downlink subframes exists, a number of PHICH groups in a subframe is mᵢ×N_{PHICH}^{group}, herein N_{PHICH}^{group} is determined according to Formula (2) and mᵢ is determined according to Table 1.

TABLE 1

| Configuration of Uplink | Serial Number i of A Subframe | | | | | | | | | |
|---|---|---|---|---|---|---|---|---|---|---|
| and Downlink Subframes | 0 | 1 | 2 | 3 | 4 | 5 | 6 | 7 | 8 | 9 |
| 0 | 2 | 1 | — | — | — | 2 | 1 | — | — | — |
| 1 | 0 | 1 | — | — | 1 | 0 | 1 | — | — | 1 |
| 2 | 0 | 0 | — | 1 | 0 | 0 | 0 | — | 1 | 0 |
| 3 | 1 | 0 | — | — | — | 0 | 0 | 0 | 1 | 1 |
| 4 | 0 | 0 | — | — | 0 | 0 | 0 | 0 | 1 | 1 |
| 5 | 0 | 0 | — | 0 | 0 | 0 | 0 | 0 | 1 | 0 |
| 6 | 1 | 1 | — | — | — | 1 | 1 | — | — | 1 |

PHICHs equidistribute in frequency domain and include a normal mode and an extended mode in time domains, which are indicated by a PBCH (Physical Broadcast Channel). A PHICH position of time-frequency resources is determined according to Formula (3) and Formula (4):

$${\overline{n}}_{i} = \{ \begin{matrix}( ⌊ {N}_{ID}^{cell} \cdot {n}_{{l}_{i}^{′}} / {n}_{1} ⌋ + {m}^{′} ) mod {n}_{{l}_{i}^{′}} & i = 0 \\ ( ⌊ {N}_{ID}^{cell} \cdot {n}_{{l}_{i}^{′}} / {n}_{1} ⌋ + {m}^{′} + ⌊ {n}_{{l}_{i}^{′}} / 3 ⌋ ) mod {n}_{{l}_{i}^{′}} & i = 1 \\ ( ⌊ {N}_{ID}^{cell} \cdot {n}_{{l}_{i}^{′}} / {n}_{1} ⌋ + {m}^{′} + ⌊ 2 {n}_{{l}_{i}^{′}} / 3 ⌋ ) mod {n}_{{l}_{i}^{′}} & i = 2\end{matrix} \qquad ( 3 )$$

Herein, represents a serial number of a REG where a PHICH is, l′, represents a serial number of an OFDM symbol, nₗ_{ᵢ}_{′} represents a number of REGs which includes no PCFICHs within the lᵢ′ OFDM symbol, m′ represents a number of PHICH groups, n₁ represents a number of REGs within the second OFDM symbol, N_{ID}^{cell} represents a cell identifier.

A basic unit of PDCCH resource mapping is CCE, and a CCE includes 9 unsuccessive REGs. A PDCCH is composed by successive CCEs. The CCEs available in a system are counted from 0 to N_{CCE}−1, herein, N_{CCE}=└N_{REG}/9┘, N_{REG} represents a number of REGs which are not allocated to PCFICHs or PHICHs.

The PDCCH has 4 format types, and the format includes 1 CCE, 2 CCEs, 4 CCEs and 8 CCEs respectively in each type, also known as a CCE aggregation level. And a number of REGs occupied and a number of PDCCH bits loaded at each CCE aggregation level are overlap as Table 2.

TABLE 2

| PDCCH | Number of | Numbers of | Number of |
|---|---|---|---|
| Format | CCEs | REGs | PDCCH Bits |
| 0 | 1 | 9 | 72 |
| 1 | 2 | 18 | 144 |
| 2 | 4 | 36 | 288 |
| 3 | 8 | 72 | 576 |

The PDCCH format is a mapping format of the PDCCH on physical resources and is irrelevant to PDCCH content. The PDCCH format for transporting is determined by a LTE base station (i.e., eNB), and a suitable PDCCH format is selected according to a condition of radio channel and a load within a cell. The UE searches within a control region not only a beginning position of a CCE aggregation level where a DCI (Downlink Control Indicator) is, but also a CCE aggregation level used by the eNB to send to the DCI, and the process above is called a PDCCH blind test.

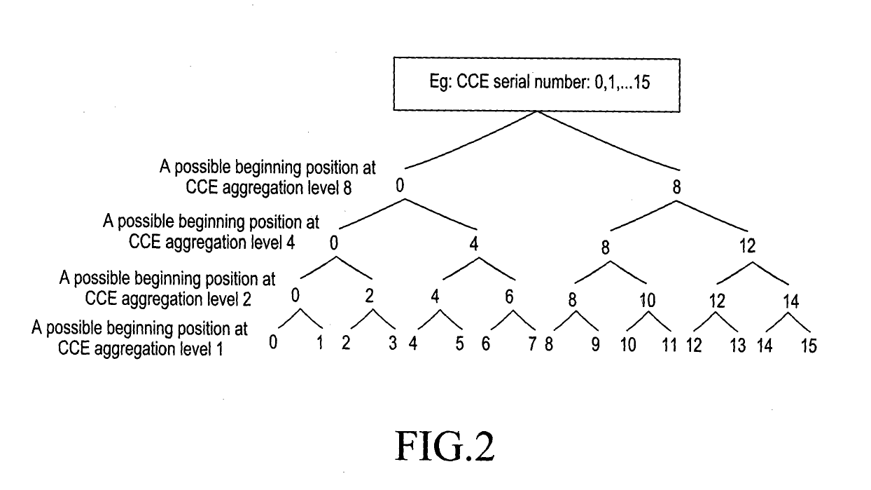

As shown in FIG. 2, to simplify a decoding process of an UE, a beginning position of different CCE aggregation level is restricted as follows:

(1) a PDCCH with 1 CCE (i.e., at CCE aggregation level 1) begins from a CCE at any position;

(2) a PDCCH with 2 CCEs (i.e., at CCE aggregation level 2) begins from a CCE at an even position;

(3) a PDCCH with 4 CCEs (i.e., at CCE aggregation level 4) begins from a CCE at a multiple position of 4;

(4) a PDCCH with 8 CCEs (i.e., at CCE aggregation level 8) begins from a CCE at a multiple position of 8.

A CCE resource set for the UE to make a PDCCH blind test is called a PDCCH search space, that is, a serial numbers of CCEs potential in PDCCHs of the UE. The PDCCH search space falls into a public search space and an UE-specific search space. Herein, the public search space is shared by any UE in a cell, and in the public search space the UE needs to experiment at CCE aggregation level 4 or level 8 just from the first CCE in a subframe. The UE-specific search space is aimed at every UE at all potential CCE aggregation levels, and a beginning position of the UE-specific search space at a CCE aggregation level is determined according to a Hash function shown in Formula 5. In the Hash function, input parameters include an UE identifier (hereinafter referred to as C-RNTI), a serial number of subframes and a total number N_{CCE} of CCEs in the current subframe.

$$\{ \begin{matrix}{Z}_{K} = {Y}_{K} mod floor ( {N}_{CCE} / {L}_{PDCCH} ) \\ {Y}_{K} = A \times {Y}_{K - 1} mod D\end{matrix} \qquad ( 5 )$$

Herein, K represents a serial number of subframes, Kε(0, 1, . . . 9), Y₋₁=n_{RNTI}, n_{RNTI} represents a numerical value of the C-RNTI, A=39827, D=65537, N_{CCE} represents a total number of CCEs in the subframe K, L_{PDCCH} represents a CCE aggregation level, Zₖ represents a beginning position of the UE-specific search space at the CCE aggregation level L_{PDCCH} in the subframe K.

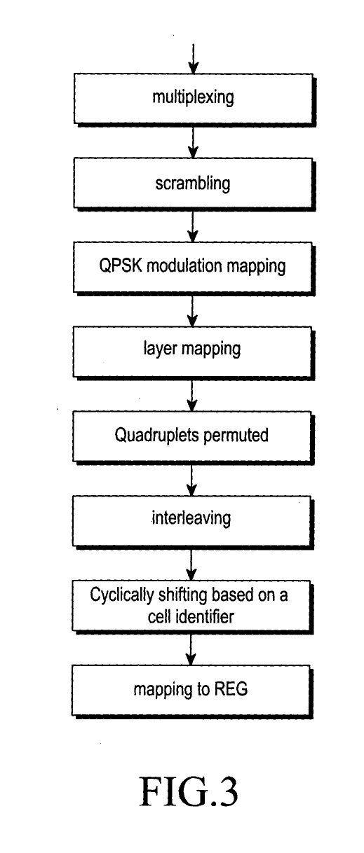

FIG. 3 is a processing procedure of a physical layer in the PDCCH. As shown in FIG. 3, an UE transports data signals in a PDCCH to achieve a mapping from a CCE to REG in the PDCCH, through a process from multiplexing, scrambling, QPSK modulation mapping, layer mapping, quadruplets permuted, interleaving, cyclically shifting based on a cell identifier to mapping to REG.

From the mapping process from the CCE to REG in the PDCCH, the PDCCH has characteristics as follows:

in a cell whose PCI is 0, 36 REGs belong to 4 CCEs with a serial number of CCEs from 0 to 3; in a cell whose PCI is 1, second 36 REGs overlapping with the first 36 REGs in frequency domain belong to CCEs with a serial number from 3 to 8; in a cell whose PCI is 2, third 36 REGs overlapping with the first 36 REGs in frequency domain belong to CCEs with a serial number from 7 to 14, and et cetera. In the light of this, the 36 REGs in a cell whose PCI is 0 only overlap in frequency domain with some CCEs in other cells, and do not overlap with the rest CCEs as shown in Table 3:

TABLE 3

| Serial | PCI | | | | | | | | | | | | |
|---|---|---|---|---|---|---|---|---|---|---|---|---|---|
| Number | 0 | 1 | 2 | 3 | 4 | 5 | 6 | 7 | 8 | 9 | 10 | 11 | 12 |
| 1 | 0 | 4 | 11 | 15 | 18 | 22 | 25 | 29 | 32 | 36 | 40 | 43 | 47 |
| 2 | 2 | 6 | X | X | X | X | X | X | X | X | X | X | X |
| 3 | 1 | 5 | 8 | 12 | 16 | 19 | 23 | 26 | 30 | 33 | 37 | X | X |
| 4 | 0 | 3 | 7 | 10 | 14 | 17 | 21 | 24 | 28 | 32 | 35 | 39 | 42 |
| 5 | 3 | 7 | 10 | 14 | 17 | 21 | 24 | 28 | 32 | 35 | 39 | 42 | 46 |
| 6 | 1 | 4 | 8 | 12 | 15 | 19 | 22 | 26 | 29 | 33 | 36 | 40 | 44 |
| 7 | 3 | 6 | 10 | 13 | 17 | 20 | 24 | 28 | 31 | 35 | 38 | 42 | 45 |
| 8 | 2 | 5 | 9 | 12 | 16 | 20 | 23 | 27 | 30 | 34 | 37 | 41 | 44 |
| 9 | 0 | 4 | 7 | 11 | 14 | 18 | 21 | 25 | 28 | 32 | 36 | 39 | 43 |
| 10 | 1 | 8 | 11 | 15 | 18 | 22 | 26 | 29 | 33 | 36 | 40 | 43 | 47 |
| 11 | 2 | 6 | 10 | 13 | 17 | 20 | 24 | 31 | 34 | 38 | 42 | 45 | 49 |
| 12 | 2 | 5 | 9 | 12 | 16 | 19 | 23 | 26 | 30 | 34 | 37 | 41 | 44 |
| 13 | 0 | 3 | 10 | 14 | 21 | 28 | 32 | 35 | 39 | 42 | 46 | 50 | 53 |
| 14 | 3 | 7 | 14 | 18 | 25 | 32 | 35 | 39 | 42 | 46 | 50 | 53 | 57 |
| 15 | 1 | 5 | 8 | 12 | 15 | 19 | 22 | 30 | 37 | 40 | 47 | 54 | 58 |
| 16 | 3 | 6 | 10 | 14 | 17 | 21 | 24 | 28 | 31 | 35 | 38 | 42 | 46 |
| 17 | 2 | 6 | 9 | 13 | 16 | 20 | 23 | 27 | 30 | 34 | 38 | 41 | 45 |
| 18 | 0 | 4 | 7 | 11 | 14 | 18 | 22 | 25 | 29 | 32 | 36 | 39 | 43 |
| 19 | 0 | X | 11 | 15 | 18 | 22 | 25 | 29 | 32 | 36 | 39 | 43 | 47 |
| 20 | 2 | 6 | 9 | 13 | 16 | 20 | 23 | X | 34 | 38 | 41 | 45 | 48 |
| 21 | 1 | 5 | 8 | 12 | 15 | 19 | 23 | 26 | 30 | 33 | 37 | 40 | 44 |
| 22 | 3 | 7 | 10 | 14 | 17 | 21 | 24 | 28 | 31 | 35 | 39 | 42 | 46 |
| 23 | 1 | 4 | 8 | 11 | 15 | 19 | 22 | 26 | 29 | 33 | 36 | 40 | 43 |
| 24 | 3 | 6 | 10 | 13 | 17 | 20 | 24 | 27 | 31 | 35 | 38 | 42 | 45 |
| 25 | 2 | 5 | 12 | 16 | 23 | 30 | 34 | 41 | 48 | 51 | 59 | 62 | 66 |
| 26 | 0 | 3 | 7 | 11 | 14 | 18 | 21 | 25 | 28 | 32 | 39 | 46 | 50 |
| 27 | 3 | 7 | 11 | 14 | 18 | 21 | 25 | 28 | 32 | 35 | X | X | X |
| 28 | 1 | 4 | 11 | 15 | 18 | 22 | 25 | 29 | 33 | 36 | 40 | 43 | 47 |
| 29 | 2 | 6 | 9 | 13 | 17 | 20 | 24 | 27 | 34 | 38 | 41 | 45 | 49 |
| 30 | 1 | 5 | 9 | 12 | 16 | 19 | 23 | 26 | 30 | 33 | 37 | 41 | 44 |
| 31 | 0 | 3 | 7 | 10 | 14 | 17 | 21 | 25 | 28 | 32 | 35 | 39 | 42 |
| 32 | 3 | 7 | 10 | 14 | 17 | 21 | 25 | 28 | 32 | 35 | 39 | 42 | 46 |
| 33 | 1 | 5 | 8 | 12 | 15 | 19 | 22 | 26 | 29 | 33 | 37 | 40 | 44 |
| 34 | 3 | 6 | 10 | 13 | 17 | 21 | 24 | 28 | 31 | 35 | 38 | 42 | 45 |
| 35 | 2 | 5 | 9 | 13 | 16 | 20 | 23 | 27 | 30 | 34 | 37 | 41 | 45 |
| 36 | 0 | 4 | 7 | 11 | 14 | 18 | 21 | 25 | 29 | 32 | 36 | 39 | 43 |

Notes:
X represents a REG carrying PHICHs and PCFICHs.

Based on the analysis of above characteristics and a relationship between the search space of the PDCCH and the C-RNTI and the serial number of subframes for the UE, following embodiments of the present application provide a method and a device to coordinately allocate PDCCH resources among several neighboring cells.

In following embodiments, what cell/UE is only a name made to describe conveniently, does not mean a certain cell/UE but may mean any cell/UE.

### Embodiment 1

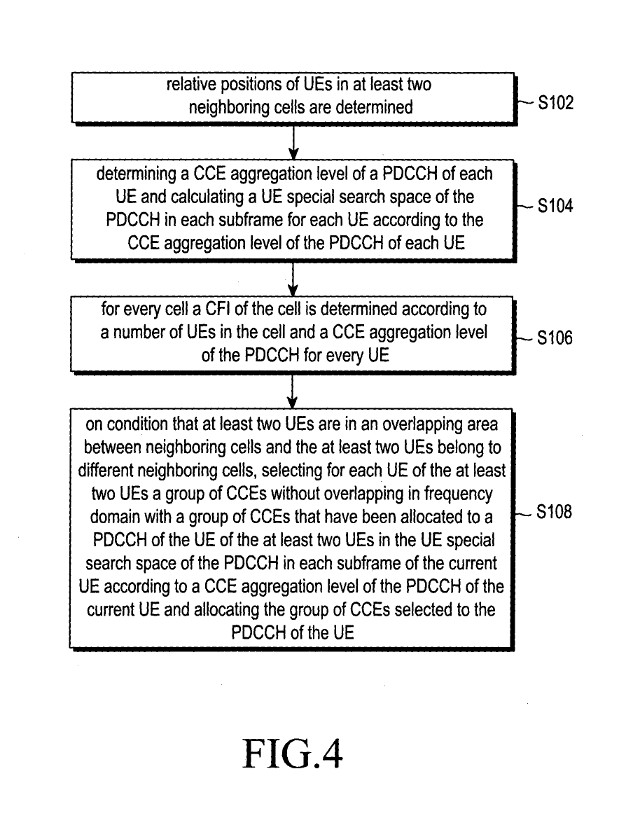

As shown in FIG. 4, a method of resource allocation in PDCCHs includes steps as follows:

At Step S102, relative positions of UEs in at least two neighboring cells are determined;

Herein, the method of determining the relative positions of UEs in at least two neighboring cells includes Step 11 and Step 12:

at Step 11, for every cell, an uplink signal strength of an UE in the cell measured in the cell and an uplink signal strength of an UE in neighboring cells measured in the cell;

at Step 12, for every UE in every cell, the relative position of the UE is determined according to the uplink signal strength of the UE in the cell measured in the cell and the uplink signal strength of the UE measured in the S neighboring cells, herein S is a positive integer greater than 0.

Specifically, the determining may be made under following situations:

Situation 1: if |Q₁₁−Qⱼ₁|<Z_{Threshold}, determine that the UE within the current cell is located in the overlapping area between the current cell and above S cells;

Situation 2: if Q₁₁>M_{Threshold} and |Q₁₁−Qⱼ₁|>N_{Threshold}, determine that the UE within the current cell is located in the centre area of the current cell;

Situation 3: if Q₁₁<R_{Threshold} and Q₁₁<T_{Threshold}, determine that the UE within the current cell is located in the edge area of the current cell not overlapping with above S cells.

Herein, Q₁₁, represents an uplink signal strength of the UE measured in the current cell, Q₁₁ represents an uplink signal strength of the UE measured in the cell j in the S cells, j=2, 3 . . . , (N+1), Z_{Threshold}, O_{Threshold}, M_{Threshold}, N_{Threshold}, R_{Threshold} and T_{Threshold} all represent preset thresholds.

Herein at Step S104, a method of determining a CCE aggregation level of the PDCCH for the UE includes: according to information of wireless signal quality feedbacked by the UE obtained from the eNB in the cell where the UE is, determining the CCE aggregation level of PDCCH for the UE. The information of wireless signal quality includes CQIs and HARQ DTXs.

At Step S104, a transmitting power of the UE is determined as well as the CCE aggregation level of the PDCCH of the UE.

At Step S104, the method of calculating an UE-specific search space of the PDCCH in each subframe includes Step 21 and Step 22:

At Step 21, a beginning position of an UE-specific search space of the PDCCH of the UE in each subframe is calculated according to a C-RNTI of the UE and the CCE aggregation level of the PDCCH for the UE.

Specifically, the beginning position of the UE-specific search space of PDCCH in each subframe may be determined according to Formula 5.

At Step 22, the size of the UE-specific search space of the PDCCH in each subframe of the UE is determined according to the CCE aggregation level of the PDCCH for the UE.

Specifically, the size of the UE-specific search space of PDCCH is 6 at CCE aggregation level 1, 12 at CCE aggregation level 2, 8 at CCE aggregation level 4, and 16 at CCE aggregation level 8.

Therefore, calculate the beginning position of the UE-specific search space at Step 21, determine the size of the UE-specific search space (recorded as Sum), and the UE-specific search space is successive Sum CCEs from the beginning position.

At Step S106, for every cell a CFI of the cell is determined according to a number of UEs in the cell and a CCE aggregation level of the PDCCH for every

UE;

at Step S108, once determining that at least two UEs are in an overlapping area between neighboring cells and the at least two UEs belong to different neighboring cells, for every UE of the at least two UE, a group of CCEs without overlapping in frequency domain with a group of CCEs that have been allocated to PDCCHs for other UE of the at least two UEs is selected in the UE-specific search space of the PDCCH in each subframe of the current UE according to a CCE aggregation level of the PDCCH for the current UE, and allocate the group of CCEs to PDCCHs of the current UE.

At Step S108, a method of selecting a group of CCEs without overlapping in frequency domain with a group of CCEs that have been allocated to a PDCCH for other UE of the at least two UEs includes: executing Step A1 to Step H1 to the current UE in each subframe:

at Step A1, for each subframe, to find a group of CCEs for the current UE in a preset mapping relationship table according to the PCI and CFI of the current UE and each the other UEs of the at least two UEs that has been allocated with CCEs and locates in different cells from the current UE, and the group of CCEs finding above is overlapping in frequency domain with a group of CCEs that has been allocated to each the other UEs; then execute Step B1;

Herein, if the current UE is the first UE of the at least two UEs allocated with CCEs, not excute Step A1 and directly execute Step B1.

Besides at Step A1, not execute Step A1 to other UE of the at least two UEs that has been allocated with CCEs in the same cell as the current UE.

At Step B1, for the current UE and for each subframe, excluding the group of CCEs that has been found at step A1 from the UE-specific search space of the current UE and then selecting a group of successive CCEs for the current UE in the remaining CCEs, where the UE-specific search space of the current UE is calculated according to the CCE aggregation level of the PDCCH of the current UE;

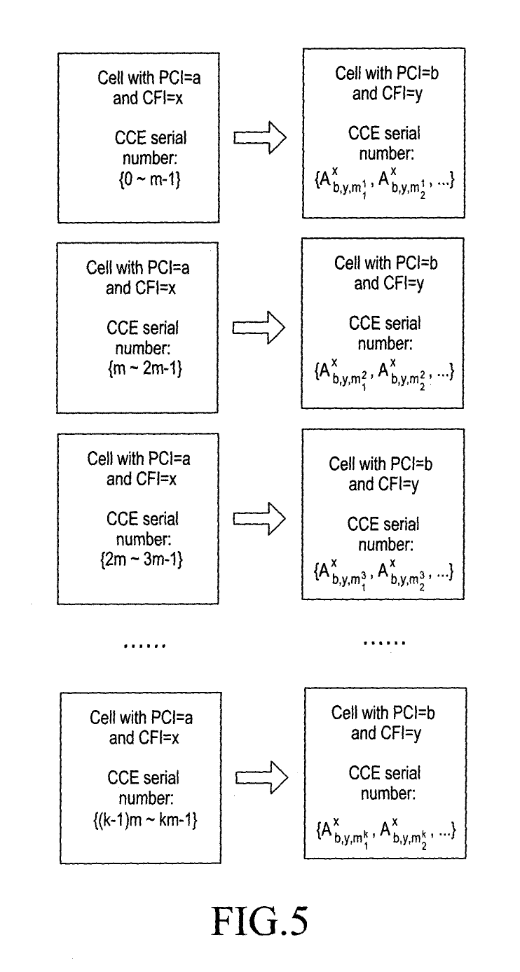

Herein as shown in FIG. 5, in the mapping relationship table, there is corresponding relationship saved between a group of CCEs with serial numbers {(k−1)m˜km−1} in a cell with a CFI x and a PCI a, and a group of CCEs with serial numbers {A_{b,y,m}_{₁}_{^{k}}^{x},A_{b,y,m}_{₂}_{^{k}}^{x},A_{b,y,m}_{₃}_{^{k}}^{x}, . . . } in a cell with a CFI y and a PCI b, and the two group of CCEs overlap in frequency domain; 1≦x≦M and M represents a CFI maximum value, and 0≦a≦N and N represents a PCI maximum value, k=1, 2, 3, . . . , m represents a preset granularity, y=1, 2, . . . , M, b=0, 1, N and b≠a, {A_{b,y,m}_{₁}_{^{k}}^{x},A_{b,y,m}_{₂}_{^{k}}^{x},A_{b,y,m}_{₃}_{^{k}}^{x}, . . . } represents serial numbers of a preset group of CCEs. m may be variable in accordance with the complexity of the mapping relationship table and its optional value is suggested to be 1, 2, 4 or 8; and in practice, N=503 and M=4.

At Step B1, a mode of selecting a group of successive CCEs in the UE-specific search space may specifically include: selecting a group of CCEs in the UE-specific search space which are equal to the CCE aggregation level in size with beginning positions conforming to FIG. 2. For example, if the CCE aggregation level is 4 and the UE-specific search space is {0,1,2,3,4,5,6,7}, the group of CCEs selected may be {0,1,2,3} or {4,5,6,7}.

Herein, if the current UE is the first UE of the at least two UEs allocated with CCEs, at Step B1, according to the CCE aggregation level of the PDCCH for the current UE, directly select any group of successive CCEs for the current UE in the UE-specific search space in the subframe of the current UE.

At Step C1, if a group of CCEs cannot be selected for the current UE at Step B1, degrading the CCE aggregation level of the PDCCH for the current UE and enhancing the transmitting power of the current UE, recalculate an UE-specific search space in the subframe according to the degraded CCE aggregation level, and repeatedly execute Step B1 to the current UE.

At Step C1, degrading the CCE aggregation level may be made gradually. For example, if the current CCE aggregation level is 8, firstly reduce it to 4; and the transmitting power may be suitably enhanced according to the reduction rating, e.g., enhance with 3 dB.

At Step D1, if a group of CCEs cannot be selected for the current UE at Step C1, reselect and reallocate a group of CCEs for other UE of the at least two UEs that has been allocated with CCEs; and then execute Step A1 to Step C1 to the current UE.

At Step D1, the process of reselecting and reallocating a group of CCEs for other UE of the at least two UEs that has been allocated with CCEs may be made as follows: firstly reselect a group of successive CCEs for an UE of the at least two UEs that is the first allocated with CCEs (for convenience of description, recorded as the first other UE), and obviously the group of CCEs reselected are different from the group of CCEs original selected; because the CCEs allocated to the first other UE have been changed, then reselect CCEs at Step A1 to Step H1 for other UE except the first other UE that has been allocated with CCEs.

For example, the at least two UEs are UE1 and UE2 in Cell 1 and UE3 and UE4 in Cell 2. The sequence of allocating is UE1, UE2, UE3 and UE4, and the current UE is UE4. So first reselect and allocate a group of CCEs for UE1, suppose that a CCE aggregation level for UE1 is 4 and an UE-specific search space is {0,1,2,3,4,5,6,7}, the group of CCEs originally selected is {0,1,2,3}, thus the group of CCEs reselected may be {4,5,6,7}; then reselect a group of CCEs for UE2; finally reselect and reallocate a group of CCEs for UE3 at Step A1 to Step H1, and in this way reselect CCEs for all the other UEs that have been allocated with CCEs before the current UE.

At Step E1, if a group of successive CCEs cannot be selected for the current UE at Step D1, degrading a CCE aggregation level of the PDCCH for the first other UE that is the first of the at least two UEs allocated with CCEs and enhance transmitting power of the first other UE, and recalculate an UE-specific search space in the subframe of the first other UE according to the CCE aggregation level degraded; reselect and reallocate a group of CCEs for the first other UE in the subframe; then repeatedly execute Step F1.

Specifically, according to the degraded CCE aggregation level, in the UE-specific search space recalculated, reselect a group of CCEs and allocate them to the first other UE.

At Step F1, reselect and reallocate a group of CCEs for other UEs except the first other UE that have been allocated with CCEs; then excute Step G1.

Specifically, for each the other UEs except the first other UE that has been allocated with CCEs, reselect and reallocate a group of CCEs for the other UEs at Step A1 to Step H1.

At Step G1, repeatedly execute Step A1 to Step D1 to the current UE. At Step H1, if a group of successive CCEs cannot be selected for the current UE at Step G1, exit the current procedure.

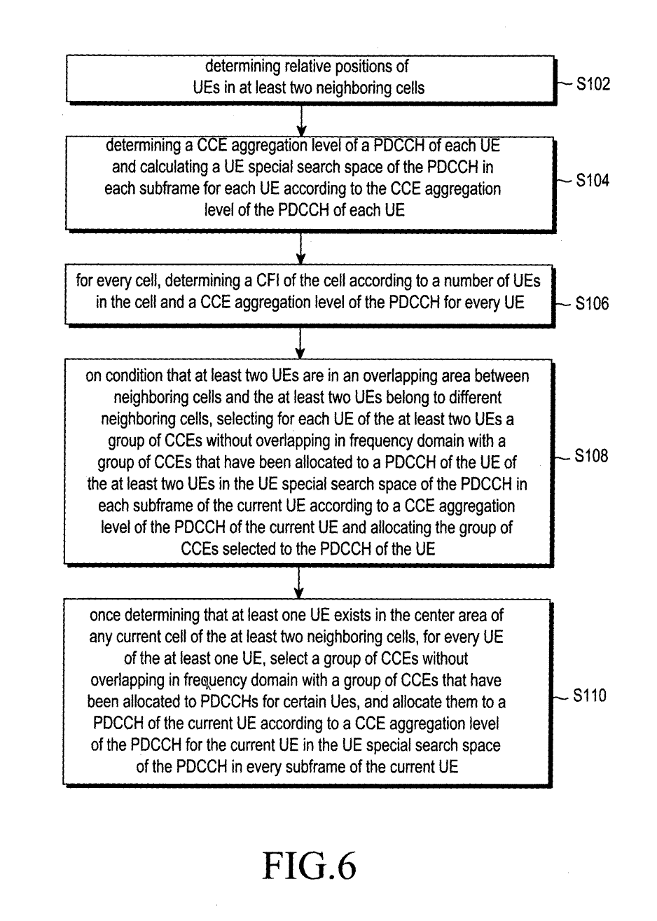

Besides, the method also includes as shown in FIG. 6:

At Step S110, once determining that at least one UE located in the center area of any current cell of the at least two neighboring cells, for every UE of the at least one UE, according to a CCE aggregation level of the PDCCH for the current UE, selecting a group of CCEs without overlapping in frequency domain with a group of CCEs that have been allocated to PDCCHs for certain UEs from the UE-specific search space of the PDCCH of the current UE for each subframe and allocating them to a PDCCH of the current UE; wherein, the certain UEs comprise: UEs at the edge of other cell neighboring the current cell, and UEs of the other cells located in an overlapping area between the current cell and the other cells.

Herein, the method of selecting a group of CCEs without overlapping in frequency domain with a group of CCEs that have been allocated to PDCCHs of the certain UEs includes: executing Step A2 to Step E2 in each subframe for the current UE:

At Step A2, for each subframe, to find a group of CCEs for the current UE in a preset mapping relationship table according to the PCI and CFI of the current UE and each the other UEs of the certain UEs that has been allocated with CCEs, and the group of CCEs finding above is overlapping in frequency domain with a group of CCEs that has been allocated to each the other UEs; then execute Step B2.

At Step B2, for the current UE and for each subframe, excluding the group of CCEs that has been found at step A2 from the UE-specific search space of the current UE and then selecting a group of successive CCEs for the current UE in the remaining CCEs, where the UE-specific search space of the current UE is calculated according to the CCE aggregation level of the PDCCH of the current UE; then execute Step C2.

At Step C2, for each subframe, if a group of successive CCEs cannot be selected for the current UE at step B2, excluding the UEs at the edge of other cell neighboring the current cell from certain UE and then executing step B2; then execute Step D2.

At Step D2, for the current UE and for each subframe, excluding the group of CCEs that has been found at step C2 from the UE-specific search space of the current UE and then selecting a group of successive CCEs for the current UE in the remaining CCEs, where the UE-specific search space of the current UE is calculated according to the CCE aggregation level of the PDCCH of the current UE; then execute Step E2.

At Step E2, if a group of successive CCEs cannot be selected for the current UE at Step D2, according to the CCE aggregation level of the PDCCH for the current UE in the UE-specific search space in the subframe, select a group of successive CCEs and decrease transmitting power of the current UE.

After executing Step108 and Step110, CCEs allocated to PDCCHs of every UE and transmitting power of every UE may be sent to a corresponding eNB. And according to the above information, the eNB may allocate PDCCH resources for every UE and adjust the transmitting power of every UE.

In the method provided in the embodiment of the present application, make that PDCCHs of several UEs in the overlapping area of neighboring cells have different frequency domain and will not have same frequency interference with each other; further, enhance the transmitting power of PDCCHs for the UEs through power control and ensure to transport more reliably; therefore, improve the reliability of transmission in PDCCH.

Besides, the method makes UEs in a center area of a cell have frequency domain different from PDCCHs of certain UEs, herein the certain UEs are UEs at the edge of neighboring cells of the current cell and UEs within neighboring cells in an overlapping area between the current cell and neighboring cells; or makes UEs in a center area of a cell have frequency domain different from PDCCHs of UEs in the overlapping area; and there is no same frequency interference among them. Further, if the UEs in a center area of a cell have the same frequency domain as the PDCCHs of UEs at the edge of neighboring cells, decrease the transmitting power of PDCCHs for the UE in the center area of the cell through power control and reduce the interference of PDCCHs for UEs at the edge of neighboring cells, so ensure the reliability of transmission in PDCCHs.

### Embodiment 2

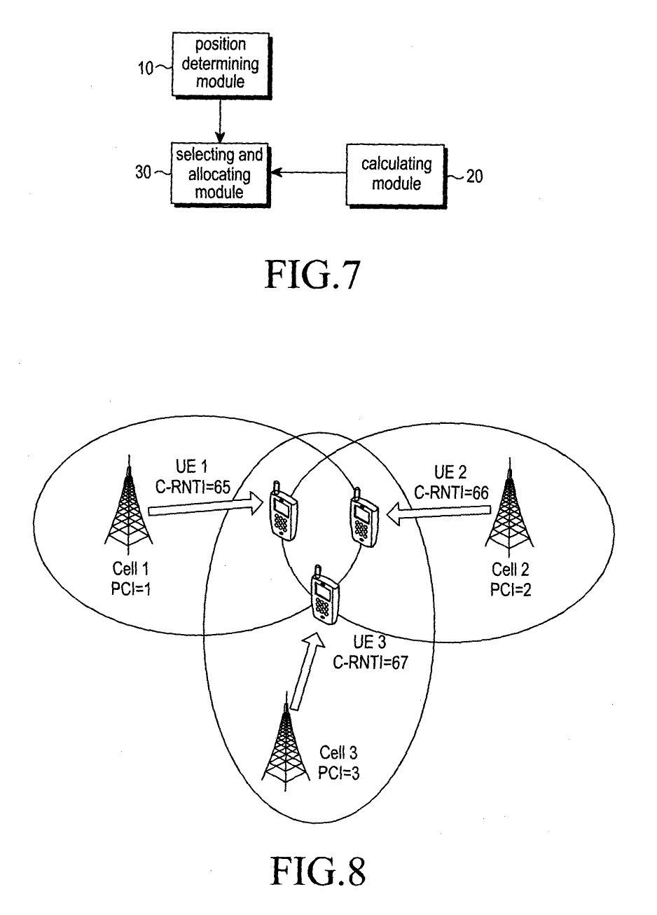

Embodiment 2 of the present application provides a device of resource allocation in PDCCHs to apply a method mentioned in Embodiment 1. As shown in FIG. 7, the device of resource allocation includes a position determining module 10, a calculating module 20 and a selecting and allocating module 30, herein:

The position determining module 10 is adapted for determining relative positions of UEs in at least two neighboring cells.

The calculating module 20 is adapted for determining a CCE aggregation level of a PDCCH for every UE, and calculating a UE-specific search space of the PDCCH for the UE in each subframe according to the CCE aggregation level of the PDCCH for every UE.

The selecting and allocating module 30 is adapted for, when the position determining module 10 determines that at least two UEs are in an overlapping area in neighboring cells and the at least two UEs belong to different neighboring cells, for every UE of the at least two UE, selecting a group of CCEs without overlapping in frequency domain with a group of CCEs that have been allocated to a PDCCH for an UE of the at least two UE in the UE-specific search space of the PDCCH in each subframe of the current UE according to a CCE aggregation level of the PDCCH for the current UE, and allocating the group of CCEs to a PDCCH for the current UE.

Specifically, the position determining module includes an obtaining element and a determining element, herein:

The obtaining element is adapted for, for every cell, obtaining an uplink signal strength of an UE in the cell measured in the cell and an uplink signal strength of an UE in neighboring cells measured in the cell.

The determining element is adapted for, for every UE in every cell, determining the relative position of the UE according to the uplink signal strength of the UE in the cell measured in the cell and the uplink signal strength of the UE measured in the S neighboring cells, herein S is a positive integer greater than 0.

Herein, the determining element is specifically applied as follows: if |Q₁₁−Q₁₁|<Z_{Threshold} determine that the UE within the current cell is located in the overlapping area between the current cell and above S cells; if Q₁₁>M_{Threshold} and |Q₁₁−Qⱼ₁|>N_{Threshold} determine that the UE within the current cell is located in the centre area of the current cell; if Q₁₁<R_{Threshold} and Q₁₁<T_{Threshold}, determine that the UE within the current cell is located in the edge area of the current cell not overlapping with above S cells; herein, Q₁₁ represents an uplink signal strength of the UE measured in the current cell, Qⱼ₁ represents an uplink signal strength of the UE measured in the cell j of the S cells, j=2, 3, . . . , (N+1), Z_{Threshold}, O_{Threshold}, M_{Threshold}, N_{Threshold}, R_{Threshold} and T_{Threshold} all represent a preset threshold.

Specifically, the calculating module includes a first calculating element, a second calculating element and a third calculating element, herein:

The first calculating element is adapted for determining the CCE aggregation level of PDCCH for the UE according to information of wireless signal quality feedbacked by the UE, and the information of wireless signal quality includes CQIs and HARQ DTXs.

The second calculating element is adapted for calculating a beginning position of an UE-specific search space of the PDCCH for the UE in each subframe according to a C-RNTI of the UE and the CCE aggregation level of the PDCCH for the UE.

The third calculating element is adapted for calculating a size of an UE-specific search space of the PDCCH for the UE in each subframe according to the CCE aggregation level of the PDCCH for the UE.

Besides, the device also includes a CFI determining module adapted for, for every cell determining a CFI of the cell according to the number of UEs in the cell and a CCE aggregation level of the PDCCH for every UE; thus the selecting and allocating module also includes a first processing element to execute following Step A1 to Step B1 in each subframe, and the detailed description of Step A1 to Step B1 is shown in Embodiment 1 and will not be listed here.

Moreover, the calculating module is also adapted for determining transmitting power of an UE as well as the CCE aggregation level of the PDCCH for the UE; thus the first processing element is also adapted for executing Step C1 to Step H1 in each subframe to the current UE, and the detailed description of Step C1 to Step H1 is shown in Embodiment 1 and will not be listed here.

The selecting and allocating module is also adapted for, when the position determining module judges that at least one UE is in an center area within any cell of the at least two neighboring cells, for every UE of the at least one UE, according to a CCE aggregation level of the PDCCH for the current UE in the UE-specific search space of the PDCCH in each subframe of the current UE, select a group of CCEs without overlapping in frequency domain with a group of CCEs that have been allocated to PDCCHs for certain UEs, and allocate the group of CCEs to the PDCCH for the current UE; herein the certain UEs include UEs at the edge of other cell neighboring the current cell and UEs within an overlapping area between the current cell and the other cells.

Herein, the selecting and allocating module also includes a second processing element adapted for executing Step A2 to Step E2 in each subframe to the current UE, and the detailed description of Step A2 to Step E2 is shown in Embodiment 1 and will not be listed here.

Specifically, the device also includes a sending module, adapted for sending CCEs allocated to PDCCHs of every UE and transmitting power of every UE to a corresponding eNB.

The device in Embodiment 2 may be within the eNB, or outside the eNB as an independent physical entity. If within the eNB, the device may coordinately allocate PDCCH resources of several cells dominated by the eNB; if outside the eNB, the device may coordinately allocate PDCCH resources among several eNBs.

### Embodiment 3

The present Embodiment 3, for example, illustrates a method in Embodiment 1 in details. And Cell a neighbors Cell b in this embodiment.

A method provided in Embodiment 3 includes steps as follows:

At Step S202, an eNB sends cell-specific parameters and UE-specific parameters of Cell a and Cell b to a device of resource allocation; herein, the cell-specific parameter is a PCI, and the UE-specific parameter is a C-RNTI and a distinctive attribute for UE uplink signals, such as CQI, or time-frequency position information about Sounding Reference Signal (hereinafter referred to as SRS), etc. The information sent is specifically shown in Table 4 and Table 5:

TABLE 4
Cell-specific Parameter and UE-specific Parameter of Cell a

| PCI | UE C-RNTI | Distinctive Attribute for UE |
|---|---|---|
| PCI a | aₓ₁ | aₓ₂ |
| PCI a | a_{y1} | a_{y2} |

Table 4 indicates that: the PCI of Cell a is PCI a, the C-RNTI of two UEs within Cell a is aₓ₁ and a_{y1} respectively, and the distinctive attribute for UE aₓ₁ uplink signals is aₓ₂ and the distinctive attribute for UE a_{y1} uplink signals is a_{y2}.

TABLE 5
Cell-specific Parameter and UE-specific Parameter of Cell b

| PCI | UE C-RNTI | Distinctive Attribute for UE |
|---|---|---|
| PCI b | bₓ₁ | bₓ₂ |
| PCI b | b_{y1} | b_{y2} |

Table 5 indicates that: the PCI of Cell b is PCI b, the C-RNTI of two UEs within Cell b is bₓ₁ and b_{y1} respectively, and the distinctive attribute for UE bₓ₁ uplink signals is bₓ₂ and the distinctive attribute for UE b_{y1} uplink signals is b_{y2}.

At Step S204, the eNB sends following information to the device of resource allocation: as shown in Table 6, an uplink signal strength of an UE in Cell a demodulated by Cell a, an uplink signal strength of an UE in Cell b demodulated by Cell a, and a PCI and a distinctive attribute for UE uplink signals in Cell b demodulated by Cell a from uplink signals in Cell b; as shown in Table 7, also an uplink signal strength of an UE in Cell b demodulated by Cell b, an uplink signal strength of an UE in Cell a demodulated by Cell b, and a PCI and a distinctive attribute for UE uplink signals in Cell a demodulated by Cell b from uplink signals in Cell a.

TABLE 6

| PCI | UE PCI | Distinctive Attribute for UE | Uplink Signal Strength |
|---|---|---|---|
| PCI a | PCI a | aₓ₂ | Q_{a,a,ax2} |
| | PCI a | a_{y2} | Q_{a,a,ay2} |
| | PCI b | bₓ₂ | Q_{a,b,bx2} |
| | PCI b | b_{y2} | Q_{a,b,by2} |

TABLE 7

| PCI | UE PCI | Distinctive Attribute for UE | Uplink Signal Strength |
|---|---|---|---|
| PCI b | PCI a | aₓ₂ | Q_{b,a,ax2} |
| | PCI a | a_{y2} | Q_{b,a,ay2} |
| | PCI b | bₓ₂ | Q_{b,b,bx2} |
| | PCI b | b_{y2} | Q_{b,b,by2} |

At Step S206, the eNB sends following information to the device of resource allocation, such as C-RNTIs of UEs in Cell a and Cell b, CQIs feedbacked by UEs and HARQ DTXs feedbacked by UEs;

specifically, the information sent is shown in Table 8 and Table 9:

TABLE 8
Information Sent by the eNB for Cell a

| PCI | UE C-RNTI | CQI Information | HARQ DTX Information |
|---|---|---|---|
| PCI a | aₓ₁ | Cₐₓ₁ | Dₐₓ₁ |
| | a_{y1} | C_{ay1} | D_{ay1} |

TABLE 9
Information Sent by the eNB for Cell b

| PCI | UE C-RNTI | CQI Information | HARQ DTX Information |
|---|---|---|---|
| PCI b | bₓ₁ | C_{bx1} | D_{bx1} |
| | b_{y1} | C_{by1} | D_{by1} |

At Step S208, once receiving the above information, the device of resource allocation calculates the information of relative positions for every UE in according to a method at Step S102 provided in Embodiment 1. Suppose that, the calculation is shown in Table 10:

TABLE 10

| PCI | UE C-RNTI | Position Information |
|---|---|---|
| PCI a | aₓ₁ | in an overlapping area between Cell a and Cell b |
| PCI a | a_{y1} | in a centre area |
| PCI b | bₓ₁ | in an overlapping area between Cell a and Cell b |
| PCI b | b_{y1} | in an edge area not overlapping with Cell a |

At Step S210, the device of resource allocation calculates CFIs in Cell a and Cell b, serial numbers of CCEs of PDCCHs and transmitting power of PDCCHs for UE aₓ₁, a_{y1}, and b_{y1}, and details are described at Step1 to Step7 as follows:

At Step1, calculate a CCE aggregation level of a PDCCH and the transmitting power for every UE.

At Step2, confirm the CFI of every cell.

At Step3, for every UE, calculate an UE-specific search space of the PDCCH in each subframe for the UE.

At Step4, allocate CCEs to UEs in an overlapping area between Cell a and Cell b, that is, allocate CCEs to the two UEs whose C-RNTI is aₓ₁ (hereinafter simply referred to as UE aₓ₁) and bₓ₁ (hereinafter simply referred to as UE bₓ₁) respectively.

Specifically, execute following steps in each subframe:

At Step4.1, select a group of CCEs in an UE-specific search space of the PDCCH for UE aₓ₁.

At Step4.2, according to a mapping relationship table shown in FIG. 5, confirm a serial number of a CCE in Cell b that overlaps in frequency domain with a CCE serial number CCEₐₓ₁.

At Step4.3, remove all serial numbers of CCEs confirmed at Step4.2 in the UE-specific search space in the subframe of UE bₓ₁ obtained at Step3, then according to the CCE aggregation level of the PDCCH for UE bₓ₁ obtained at Step1, select a serial number of CCE CCE_{bx1} for the PDCCH of UE bₓ₁ in the remaining UE-specific search space, so ensure CCE_{bx1} not to overlap with CCEₐₓ₁ in frequency domain.

At Step4.4, if Step4.3 cannot be completed, reduce the CCE aggregation level of the PDCCH for UE bₓ₁ and enhance suitable transmitting power, then according to the CCE aggregation level degraded, recalculate an UE-specific search space of the PDCCH for UE bₓ₁ in the subframe and repeat Step 4.3.

At Step4.5, if Step4.4 cannot be completed, reselect a serial number of other CCE CCEₐₓ₁ in the UE-specific search space of the PDCCH for UE aₓ₁ in the subframe, and repeat Step 4.2 to Step4.4.

At Step4.6, if Step4.5 cannot be completed, reduce the CCE aggregation level of the PDCCH for UE aₓ₁, then according to the CCE aggregation level degraded, recalculate an UE-specific search space of the PDCCH for UE aₓ₁ in the subframe, reselect and reallocate a serial number of other CCE CCEₐₓ₁ for UE aₓ₁, repeat Step 4.2 to Step4.5.

At Step4.7, if Step4.6 cannot be completed, exit the procedure of selecting and allocating CCEs for UE bₓ₁ in the subframe.

At Step5, allocate serial numbers of CCEs of PDCCHs for UEs in an edge area within Cell a and Cell b; there is no UE in an edge area within Cell a, so only allocate serial numbers of CCEs of PDCCHs for UE b_{y1} in Cell b.

At Step6, allocate serial numbers of CCEs of PDCCHs for UE a_{y1} in a centre area within Cell a.

Specifically, execute following steps in each subframe:

at Step6.1, according to a mapping relationship table shown in FIG. 5, locate in Cell a serial numbers of CCEs in Cell an overlapping in frequency domain with serial numbers of CCEs that have been allocated to UE bₓ₁ in Cell b, and serial numbers of CCEs overlapping in frequency domain with serial numbers of CCEs that have been allocated to UE b_{y1} in Cell b.

At Step6.2, remove all serial numbers of CCEs confirmed at Step6.1 in the UE-specific search space of the PDCCH for UE a_{y1} in the subframe recalculated at Step3, then according to the CCE aggregation level of the PDCCH for UE a_{y1} a group of successive CCE serial numbers in the remaining UE-specific search space and allocate them to PDCCHs of UE a_{y1}, therefore ensure the serial numbers of CCEs selected are different from the serial numbers of CCEs located at Step6.1.

At Step6.3, if Step6.2 cannot be completed, in the mapping relationship table shown in FIG. 5, locate serial numbers of CCEs in Cell that overlap in frequency domain with serial numbers of CCEs for UE bₓ₁ in Cell b; then execute Step6.4.

At Step6.4, remove all serial numbers of CCEs located at Step6.3 in the UE-specific search space in the subframe for UE a_{y1} calculated at Step3, then according to the CCE aggregation level of the PDCCH for UE a_{y1}, select a serial number of successive CCEs in the remaining UE-specific search space and allocate them to the PDCCH of UE a_{y1}, therefore ensure the serial numbers of CCEs selected are different from the serial numbers of CCEs located at Step6.3.

At Step6.5, if Step6.4 cannot be completed, according to the CCE aggregation level of the PDCCH for UE a_{y1} in the UE-specific search space for UE a_{y1} in the subframe calculated at Step3, select a group of successive CCE serial numbers and allocate them to the PDCCH of UE a_{y1}, and decrease the transmitting power.

At Step7, in the method at Step6, allocate CCE serial numbers of PDCCHs for UEs in a centre area within Cell b. There is no UE in the centre area within Cell b, so not execute this step.

At Step S212, the device of resource allocation send to the eNB the information about the CFI of every cell, CCE serial numbers of PDCCHs for every UE and the transmitting power of every UE.

Specifically, the information sent is shown in Table 11 and Table 12:

TABLE 11

| PCI | CFI | UE C-RNTI | PDCCH | Transmitting Power |
|---|---|---|---|---|
| PCI a | CFIₐ | aₓ₁ | CCEₐₓ₁ | pₐₓ₁ |
| | | a_{y1} | CCE_{ay1} | p_{ay1} |

TABLE 12

| PCI | CFI | UE C-RNTI | PDCCH | Transmitting Power |
|---|---|---|---|---|
| PCI b | CFI_{b} | bₓ₁ | CCE_{bx1} | p_{bx1} |
| | | b_{y1} | CCE_{by1} | p_{by1} |

At Step S213, once receiving the information shown in Table 11 or Table 12, the eNB send the information to corresponding UEs.

### Embodiment 4

Through a practical application scenario, the present embodiment describes methods mentioned in above embodiments.

Cell 1, Cell 2 and Cell 3 are three neighbor cells, and a PCI of them is 1, 2 and 3 respectively, an UE of them is UE1, UE2 and UE3 respectively, a C-RNTI of UE1, UE2 and UE3 is 65, 66 and 67 respectively, and the three UEs all locate in an overlapping area within the three cells.

A method of resource allocation in PDCCHs in the present embodiment includes steps as follows:

At Step S302, a device of resource allocation determines that UE1, UE2 and UE3 locate in an overlapping area between Cell 1, Cell 2 and Cell 3.

At Step S304, according to information about CQIs and HARQ DTXs feedbacked by every UE, the device of resource allocation confirms that a CCE aggregation level of the PDCCH for every UE is 8 and no enhancement is made to transmitting power for every UE.

At Step S306, for every cell, according to a number of UEs in a cell and the CCE aggregation level of PDCCHs for every UE, the device of resource allocation confirms a CFI of the cell and supposes that the CFI in the three cells are all 3.

At Step S308, the device of resource allocation calculates an UE-specific search space (8CCE) in each subframe for UE1, UE2 and UE3 as shown in Table 13:

TABLE 13

| | UE-specific Search | | |
|---|---|---|---|
| | Space (8CCE) | | |
| Subframe | UE1 | UE2 | UE3 |
| 0 | 16~31 | 16~31 | 72~7 |
| 1 | 8~23 | 72~7 | 56~71 |
| 2 | 56~71 | 64~79 | 72~7 |
| 3 | 56~71 | 72~7 | 8~23 |
| 4 | 40~55 | 72~7 | 48~63 |
| 5 | 72~7 | 0~15 | 8~23 |
| 6 | 40~55 | 48~63 | 56~71 |
| 7 | 56~71 | 48~63 | 16~31 |
| 8 | 72~7 | 32~47 | 72~7 |
| 9 | 64~79 | 16~31 | 48~63 |

At Step S310, the device of resource allocation allocates PDCCH resources for UE1, UE2 and UE3.

Specifically, the process includes following steps:

At Step S3101, considering that the CCE aggregation level of the PDCCH for UE1 is 8, select 8 successive CCE serial numbers in the UE-specific search space (8CCE) in each subframe and allocate them to UE1 as shown in Table 14:

TABLE 14

| | UE-specific Search Space | Serial Numbers of CCEs |
|---|---|---|
| Subframe | for UE1 (8CCE) | Allocated to PDCCHs of UE1 |
| 0 | 16~31 | 24~31 |
| 1 | 8~23 | 8~15 |
| 2 | 56~71 | 56~63 |
| 3 | 56~71 | 56~63 |
| 4 | 40~55 | 40~47 |
| 5 | 72~7 | 72~79 |
| 6 | 40~55 | 40~47 |
| 7 | 56~71 | 64~71 |
| 8 | 72~7 | 72~79 |
| 9 | 64~79 | 64~71 |

At Step S3102, locate in a mapping relationship table shown in FIG. 5 serial numbers of CCEs in Cell 2 and Cell 3 that overlap in frequency domain with the serial numbers of CCEs allocated to UE1 as shown in Table 15:

TABLE 15

| | |
|---|---|
| | Serial Numbers of |
| | CCEs Overlapping |
| | in Frequency |
| CCE Serial | domain with CCEs |
| Numbers of | Allocated to UE1 |

| Subframe | PDCCHs for UE1 | Cell 2 | Cell 3 |
|---|---|---|---|
| 0 | 24~31 | 27~38 | 31~40 |
| 1 | 8~15 | 11~22 | 15~26 |
| 2 | 56~63 | 59~70 | 63~74 |
| 3 | 56~63 | 59~70 | 63~74 |
| 4 | 40~47 | 43~54 | 47~57 |
| 5 | 72~79 | 75~3 | 79~3 |
| 6 | 40~47 | 43~54 | 47~57 |
| 7 | 64~71 | 67~76 | 71~81 |
| 8 | 72~79 | 75~3 | 79~3 |
| 9 | 64~71 | 67~76 | 71~81 |

At Step S3103, remove all serial numbers of CCEs located in an UE-specific search space in the subframe for UE2, then considering that the CCE aggregation level of PDCCH for UE2 is 8, select 8 successive CCE serial numbers in the remaining UE-specific search space and allocate them to UE2, thus ensure PDCCHs of UE1 and PDCCHs of UE2 will not overlap in frequency domain; and a final result of allocating PDCCHs for UE2 is shown as Table 16:

TABLE 16

| | UE-specific | Serial Numbers of | |
|---|---|---|---|
| | Search | CCEs Overlapping in | Serial Numbers of |
| | Space for | Frequency domain | CCEs Allocated to |
| Subframe | UE2 (8CCE) | with CCEs of UE1 | PDCCHs of UE2 |
| 0 | 16~31 | 27~38 | 16~23 |
| | | | (24~31non-allocable) |
| 1 | 72~7 | 11~22 | 72~79 |
| 2 | 64~79 | 59~70 | 72~79 |
| | | | (64~71non-allocable) |
| 3 | 72~7 | 59~70 | 0~7 |
| 4 | 72~7 | 43~54 | 0~7 |
| 5 | 0~15 | 75~3 | 8~15 |
| | | | (0~7 non-allocable) |
| 6 | 48~63 | 43~54 | 56~63 |
| | | | (48~55non-allocable) |
| 7 | 48~63 | 67~76 | 48~55 |
| 8 | 32~47 | 75~3 | 32~39 |
| 9 | 16~31 | 67~76 | 16~23 |

At Step S3104, in every subframe reliably me, locate in a mapping relationship table shown in FIG. 5 serial numbers of CCEs in Cell 3 that overlap in frequency domain with the serial numbers of CCEs allocated to UE2 as shown in Table 17:

TABLE 17

| | Serial Numbers of CCEs | Serial Numbers of CCEs in Cell 3 |
|---|---|---|
| | Allocated to PDCCHs of | Overlapping in Frequency domain |
| Subframe | UE2 | with CCEs Allocated to UE2 |
| 0 | 16~23 | 19~29 |
| 1 | 72~79 | 75~84 |
| 2 | 72~79 | 75~84 |
| 3 | 0~7 | 3~11 |
| 4 | 0~7 | 3~11 |
| 5 | 8~15 | 11~19 |
| 6 | 56~63 | 59~67 |
| 7 | 48~55 | 51~59 |
| 8 | 32~39 | 35~43 |
| 9 | 16~23 | 19~29 |

At Step S3105, in each subframe, remove all serial numbers of CCEs in Cell 3 located at Step S3102 and Step S3104 in an UE-specific search space in the subframe, then considering that the CCE aggregation level of PDCCH for UE3 is 8, select 8 successive CCE serial numbers in the remaining UE-specific search space for UE3; and the serial numbers of CCEs allocated to PDCCHs for UE3 are shown as Table 18:

TABLE 18

| | | Serial | Serial | |
|---|---|---|---|---|
| | | Numbers of | Numbers of | |
| | | CCEs | CCEs | |
| | UE- | Overlapping | Overlapping in | |
| | specific | in Frequency | Frequency | |
| | Search | domain with | domain with | Serial |
| | Space for | CCEs | CCEs | Numbers of CCEs |
| Sub- | UE3 | Allocated to | Allocated to | Allocated to PDCCHs |
| frame | (8CCE) | UE1 | UE2 | of UE3 |
| 0 | 72~7 | 31~40 | 19~29 | 72~79 |
| 1 | 56~71 | 15~26 | 75~84 | 56~63 |
| 2 | 72~7 | 63~74 | 75~84 | 0~7 |
| | | | | (72~79 non-allocable) |
| 3 | 8~23 | 63~74 | 3~11 | 16~23 |
| | | | | (8~15 non-allocable) |
| 4 | 48~63 | 47~57 | 3~11 | 56~63 |
| | | | | (48~55 non-allocable) |
| 5 | 8~23 | 79~3 | 11~19 | X |
| | | | | (all non-allocable) |
| 6 | 56~71 | 47~57 | 59~67 | X |
| | | | | (all non-allocable) |
| 7 | 16~31 | 71~81 | 51~59 | 16~23 |
| 8 | 72~7 | 79~3 | 35~43 | 72~79 |
| | | | | (0~7 non-allocable) |
| 9 | 48~63 | 71~81 | 19~29 | 48~55 |

At Step S3106, CCEs are not successfully allocated for UE3 in Subframe 5 and Subframe 6 at Step S3105, so reduce the CCE aggregation level of the PDCCH for UE3 to 4 and increase the transmitting with 3 dBs, and recalculate an UE-specific search space for UE3 in Subframe 5 and Subframe 6, then in the UE-specific search space in Subframe 5 and Subframe 6 remove all serial numbers of CCEs in Cell 3 located at Step S3102 and Step S3104, and considering that the CCE aggregation level of PDCCH for UE3 is 4, select 4 successive CCE serial numbers in the remaining UE-specific search space and allocate them to UE3; now the serial numbers of CCEs allocated to PDCCHs of UE3 in Subframe 5 and Subframe 6 are shown in Table 19:

TABLE 19

| | UE- | Serial | Serial | Serial |
|---|---|---|---|---|
| | specific | Numbers of CCEs | Numbers of CCEs | Numbers of |
| | Search | Overlapping in | Overlapping in | CCEs |
| | Space | Frequency domain | Frequency domain | Allocated to |
| Sub- | for UE3 | with CCEs | with CCEs | PDCCHs of |
| frame | (4CCE) | Allocated to UE1 | Allocated to UE2 | UE3 |
| 5 | 64~71 | 79~3 | 11~19 | 64~67 |
| 6 | 68~75 | 47~57 | 59~67 | 68~71 |

In a word, above embodiments of the present application can bring technical benefits as follows:

In the method provided in embodiments of the present application, make that PDCCHs of several UEs in an overlapping area of neighboring cells have different frequency domain and will not have same frequency interference with each other; further, enhance respective transmitting power of PDCCHs for the UEs through power control and ensure to transport more reliably; therefore, improve the reliability of transmission in PDCCH.

Besides, the method makes UEs in a center area of a cell have different frequency domain from PDCCHs of certain UEs, herein the certain UEs are UEs at the edge of cells neighboring the cell and UEs within neighboring cells in an overlapping area between the current cell and neighboring cells; or makes UEs in a center area of a cell have different frequency domain from PDCCHs of UEs in the overlapping area; and there is no same frequency interference among them. Further, if the UEs in the center area of a cell have the same frequency as the PDCCHs of UEs at the edge of neighboring cells, the method decreases the transmitting power of the PDCCH for the UE in the center area of the cell through power control and reduce the interference to PDCCHs for UEs at the edge of neighboring cells, so ensures to reliably transport the PDCCHs.

The above are only better embodiments of the present invention but should not limit the invention, and any modification, equal replacement or improvement etc. on the invention without departing from the spirit and principle of the present invention are within the scope of claims of the present invention.

1. A method of resource allocation in Physical Downlink Control Channels (PDCCHs), comprising:
determining relative positions of User Equipments (UEs) in at least two neighboring cells;
determining a Control Channel Element (CCE) aggregation level of a PDCCH of each UE, and calculating a UE-specific search space of the PDCCH in each subframe for each UE according to the CCE aggregation level of the PDCCH of each UE;
on condition that at least two UEs are in an overlapping area between neighboring cells and the at least two UEs belong to different neighboring cells, selecting for each UE of the at least two UEs a group of CCEs without overlapping in frequency domain with a group of CCEs that have been allocated to a PDCCH of the other UEs of the at least two UEs in the UE-specific search space of the PDCCH in each subframe of the current UE according to a CCE aggregation level of the PDCCH of the current UE; and
allocating the group of CCEs selected to the PDCCH of the UE.

2. The method according to claim 1, wherein determining the relative positions of the UEs in the at least two neighboring cells comprises:
for each cell, obtaining an uplink signal strength of an UE in the cell measured in the cell and an uplink signal strength of an UE in neighboring cells measured in the cell;
for each UE in each cell, determining the relative position of the UE according to the uplink signal strength of the UE measured in the cell and the uplink signal strength of the UE measured in the S neighboring cells, wherein S is a positive integer greater than 0.

3. The method according to claim 2, wherein determining the relative position of the UE comprises:
if |Q₁₁−Qⱼ₁|<Z_{Threshold}, determining that the UE within the cell is located in the overlapping area between the cell and the S neighboring cells;
if Q₁₁>M_{Threshold} and |Q₁₁−Qⱼ₁|>N_{Threshold}, determining that the UE within the cell is located in the center area of the cell;
if Q₁₁<R_{Threshold} and Qⱼ₁<T_{Threshold} determining that the UE within the cell is located in the edge area of the cell which is not overlapping with above S cells;
wherein Q₁₁ represents an uplink signal strength of the UE measured in the cell, Qⱼ₁ represents an uplink signal strength of the UE measured in cell j of the S neighboring cells, j=2, 3, . . . , (N+1), Z_{Threshold}, O_{Threshold}, M_{Threshold}, N_{Threshold}, R_{Threshold} and T_{threshold} all represent preset thresholds.

4. The method according to claim 1, wherein determining the CCE aggregation level of the PDCCH of each UE comprises: determining the CCE aggregation level of PDCCH of each UE according to information of wireless signal quality feedbacked by the UE obtained from the eNB of the cell where the UE belongs, wherein the information of wireless signal quality comprises a Channel Quality Indicator (CQI) and Hybrid Adaptive Re-transmission Request (HARQ) Discontinuous Transmission (DTX).

5. The method according to claim 1, wherein calculating the UE-specific search space of the PDCCH in each subframe comprises:
calculating a beginning position of the UE-specific search space of the PDCCH in each subframe of the UE according to a Cell Radio Network temporary Identifier (C-RNTI) of the UE and the CCE aggregation level of the PDCCH of the UE;
determining a size of the UE-specific search space of the PDCCH in each subframe of the UE according to the CCE aggregation level of the PDCCH of the UE.

6. The method according to claim 1, further comprising:
for each cell, determining a Control Format Indicator (CFI) of the cell according to the number of UEs in the cell and the CCE aggregation level of the PDCCH for each UE; wherein
selecting and allocating the group of CCEs for the other UEs of the at least two UEs without overlapping in frequency domain with a group of CCEs that have been allocated to a PDCCH of the current UE in each subframe comprises: for the current UE, executing the follow steps:
A1, for each subframe, to find a group of CCEs for the current UE in a preset mapping relationship table according to the PCI and CFI of the current UE and each the other UEs of the at least two UEs that has been allocated with CCEs and locates in different cells from the current UE, and the group of CCEs finding above is overlapping in frequency domain with a group of CCEs that has been allocated to each the other UEs;
B1, for the current UE and for each subframe, excluding the group of CCEs that has been found at step A1 from the UE-specific search space of the current UE and then selecting a group of successive CCEs for the current UE in the remaining CCEs, where the UE-specific search space of the current UE is calculated according to the CCE aggregation level of the PDCCH of the current UE;
wherein in the mapping relationship table, a corresponding relationship shall be saved between a group of CCEs with serial numbers {(k−1)m˜km−1} in a cell with a CFI x and a PCI a, and a group of CCEs with serial numbers {A_{b,y,m}_{₁}_{^{k}}^{x},A_{b,y,m}_{₂}_{^{k}}^{x},A_{b,y,m}_{₃}_{^{k}}^{x}, . . . } in a cell with a CFI y and a PCI b, and the two group of CCEs overlap in frequency domain; 1≦x≦M and M represents a CFI maximum value, 0≦a≦N and N represents a PCI maximum value, k=1, 2, 3, . . . , m represents a preset granularity, y=1, 2, . . . , M, b=0, 1, . . . , N and b≠a, {A_{b,y,m}_{₁}_{^{k}}^{x},A_{b,y,m}_{₂}_{^{k}}^{x},A_{b,y,m}_{₃}_{^{k}}^{x}, . . . } presents serial numbers of a preset group of CCEs.

7. The method according to claim 6, further comprising:
determining a transmitting power of the UE while determining the CCE aggregation level of the PDCCH of the UE: and
C1, for each subframe, if a group of successive CCEs cannot be selected for the current UE at Step B1, degrading the CCE aggregation level of the PDCCH for the current UE and enhancing the transmitting power of the current UE, recalculating an UE-specific search space in the subframe according to the degraded CCE aggregation level, and repeatedly executing Step B1 for the current UE.

8. The method according to claim 7, further comprising:
D1, for each subframe, if a group of successive CCEs cannot be selected for the current UE at Step C1, reselecting and reallocating a group of CCEs for other UE of the at least two UEs that has been allocated with CCEs; and executing Step A1 to C1 repeatedly for the current UE.

9. The method according to claim 8, further comprising:
E1, for each subframe, if a group of successive CCEs cannot be selected for the current UE at Step D1, degrading a CCE aggregation level of the PDCCH for the first other UE of the at least two UEs that has been allocated with CCEs firstly and enhancing the transmitting power of the first other UE, and recalculating an UE-specific search space in the subframe of the first other UE according to the degraded CCE aggregation level; then reselecting and reallocating a group of CCEs for the first other UE in the subframe;
F1, reselecting and reallocating a group of CCEs for other UEs except the first other UE that have been allocated with CCEs;
G1, repeatedly executing step A1 to D1 to the current UE.

10. The method according to claim 9, further comprising:
H1, for each subframe, if a group of successive CCEs cannot be selected for the current UE at Step G1, skipping the current procedure of selecting CCEs in the current subframe for the current UE.

11. The method according to claim 1, further comprising:
once determining that at least one UE located in a center area of any current cell of the at least two neighboring cells, for every UE of the at least one UE, according to a CCE aggregation level of the PDCCH for the current UE, selecting a group of CCEs without overlapping in frequency domain with a group of CCEs that have been allocated to PDCCHs for certain UEs from the UE-specific search space of the PDCCH of the current UE for each subframe and allocating them to a PDCCH of the current UE; wherein, the certain UEs comprise: UEs at the edge of other cell neighboring the current cell, and UEs of the other cells located in an overlapping area between the current cell and the other cells.

12. The method according to claim 11, wherein selecting a group of CCEs without overlapping in frequency domain with a group of CCEs that have been allocated to PDCCHs for certain UEs comprises: executing following steps in each subframe for the current UE:
A2, for each subframe, to find a group of CCEs for the current UE in a preset mapping relationship table according to the PCI and CFI of the current UE and each the other UEs of the certain UEs that has been allocated with CCEs, and the group of CCEs finding above is overlapping in frequency domain with a group of CCEs that has been allocated to each the other UEs;
B2, for the current UE and for each subframe, excluding the group of CCEs that has been found at step A2 from the UE-specific search space of the current UE and then selecting a group of successive CCEs for the current UE in the remaining CCEs, where the UE-specific search space of the current UE is calculated according to the CCE aggregation level of the PDCCH of the current UE;
wherein in the mapping relationship table, a corresponding relationship shall be saved between a group of CCEs with serial numbers {(k−1)m˜km−1} in a cell with a CFI x and a PCI a, and a group of CCEs with serial numbers {A_{b,y,m}_{₁}_{^{k}}^{x},A_{b,y,m}_{₂}_{^{k}}^{x},A_{b,y,m}_{₃}_{^{k}}^{x}, . . . } in a cell with a CFI y and a PCI b, and the two group of CCEs overlap in frequency domain; 1≦x≦M and M represents a CFI maximum value, 0≦a≦N and N represents a PCI maximum value, k=1, 2, 3, . . . , m represents a preset granularity, y=1, 2, . . . , M, b=0, 1, . . . , N and b≠a, {A_{b,y,m}_{₁}_{^{k}}^{x},A_{b,y,m}_{₂}_{^{k}}^{x},A_{b,y,m}_{₃}_{^{k}}^{x}, . . . } represents serial numbers of a preset group of CCEs.

13. The method according to claim 12, further comprising: executing the following steps:
C2, for each subframe, if a group of successive CCEs cannot be selected for the current UE at step B2, excluding the UEs at the edge of other cell neighboring the current cell from certain UE and then executing step B2;
D2, for the current UE and for each subframe, excluding the group of CCEs that has been found at step C2 from the UE-specific search space of the current UE and then selecting a group of successive CCEs for the current UE in the remaining CCEs, where the UE-specific search space of the current UE is calculated according to the CCE aggregation level of the PDCCH of the current UE.

14. The method according to claim 13, further comprising: executing the following steps for each subframe:
E2, if a group of successive CCEs cannot be selected for the current UE at step D2, selecting a group of successive CCEs randomly and decreasing a transmitting power of the current UE according to the CCE aggregation level of the PDCCH for the current UE in the UE-specific search space in the subframe.

15. The method according to claim 1, further comprising:
sending allocated CCEs and transmitting power for every UE to a corresponding eNB.

16. A device of resource allocation in Physical Downlink Control Channels (PDCCHs), comprising:
a position determining module, for determining relative positions of User Equipment (UEs) in at least two neighboring cells;
a calculating module, for determining a Control Channel Element (CCE) aggregation level of a PDCCH for each UE, and calculating a UE-specific search space of the PDCCH in each subframe according to the CCE aggregation level of the PDCCH for each UE;
a selecting and allocating module, for when the position determining module determines that at least two UEs are in an overlapping area in neighboring cells and the at least two UEs belong to different neighboring cells, selecting for each UE of the at least two UEs a group of CCEs without overlapping in frequency domain with a group of CCEs that have been allocated to a PDCCH of the UE of the at least two UEs in the UE-specific search space of the PDCCH in each subframe of the current UE according to a CCE aggregation level of the PDCCH of the current UE, and allocating the group of CCEs to a PDCCH of the current UE.

17. The device according to claim 16, wherein the position determining module comprises:
an obtaining element, for each cell, for obtaining an uplink signal strength of an UE in the cell measured in the cell and an uplink signal strength of an UE in neighboring cells measured in the cell;
a determining element, for each UE in each cell, for determining the relative position of the UE according to the uplink signal strength of the UE measured in the cell and the uplink signal strength of the UE measured in the S neighboring cells, wherein S is a positive integer greater than 0.

18. The device according to claim 17, wherein the determining element is adapted for:
if |Q₁₁−Qⱼ₁|<Z_{Threshold}, determining that the UE within the current cell is located in the overlapping area between the cell and above S neighboring cells;
if Q₁₁>M_{Threshold} and |Q₁₁−Qⱼ₁|>N_{Threshold}, determining that the UE within the current cell is located in the centre area of the current cell;
if Q₁₁<R_{Threshold} and Qⱼ₁<T_{Threshold} determining that the UE within the current cell is located in the edge area of the current cell not overlapping with above S neighboring cells;
wherein, Q₁₁ represents an uplink signal strength of the UE measured in the current cell, Qⱼ₁ represents an uplink signal strength of the UE measured in cell j of the S neighboring cells, j=2, 3, . . . , (N+1), Z_{Threshold}, O_{Threshold}, M_{Threshold}, N_{Threshold}, R_{Threshold} and T_{threshold} all represent preset thresholds.

19. The device according to claim 16, further comprising:
a CFI determining module, for determining for every cell a Control Format Indicator (CFI) of the cell according to the number of UEs in the cell and a CCE aggregation level of the PDCCH for every UE; wherein the selecting and allocating module comprises a first processing element to execute following step in each subframe for the current UE:
A1, for each subframe, to find a group of CCEs for the current UE in a preset mapping relationship table according to the PCI and CFI of the current UE and each the other UEs of the at least two UEs that has been allocated with CCEs and locates in different cells from the current UE, and the group of CCEs finding above is overlapping in frequency domain with a group of CCEs that has been allocated to each the other UEs;
B1, for the current UE and for each subframe, excluding the group of CCEs that has been found at step A1 from the UE-specific search space of the current UE and then selecting a group of successive CCEs for the current UE in the remaining CCEs, where the UE-specific search space of the current UE is calculated according to the CCE aggregation level of the PDCCH of the current UE;
wherein in the mapping relationship table, a corresponding relationship shall be saved between a group of CCEs with serial numbers {(k−1)m˜km−1} in a cell with a CFI x and a PCI a, and a group of CCEs with serial numbers {A_{b,y,m}_{₁}_{^{k}}^{x},A_{b,y,m}_{₂}_{^{k}}^{x},A_{b,y,m}_{₃}_{^{k}}^{x}, . . . } in a cell with a CFI y and a PCI b, and the two group of CCEs overlap in frequency domain; 1≦x≦M and M represents a CFI maximum value, 0≦a≦N and N represents a PCI maximum value, k=1, 2, 3, . . . , m represents a preset granularity, y=1, 2, . . . , M, b=0, 1, . . . , N and b≠a, {A_{b,y,m}_{₁}_{^{k}}^{x},A_{b,y,m}_{₂}_{^{k}}^{x},A_{b,y,m}_{₃}_{^{k}}^{x}, . . . } represents serial numbers of a preset group of CCEs.

20. The device according to claim 19, wherein the calculating module is adapted for determining a transmitting power of the UE as well as the CCE aggregation level of the PDCCH for the UE: the first processing element is also adapted for executing following steps in each subframe for the current UE:
C1, if a group of successive CCEs cannot be selected for the current UE at B1, degrading the CCE aggregation level of the PDCCH for the current UE and enhancing the transmitting power of the current UE, recalculating an UE-specific search space in the subframe according to the degraded CCE aggregation level, and repeatedly executing Step B1 for the current UE.

21. The device according to claim 20, wherein the first processing element is also adapted for executing following steps in each subframe for the current UE:
D1, if a group of successive CCEs cannot be selected for the current UE at Step C1, reselecting and reallocating a group of CCEs for other UE of the at least two UEs that has been allocated with CCEs; and then executing Step A1 to C1 repeatedly for the current UE.

22. The device according to claim 21, wherein the first processing element is also adapted for executing following steps in each subframe to the current UE:
E1, if a group of successive CCEs cannot be selected for the current UE at Step D1, degrading a CCE aggregation level of the PDCCH for the first other UE of the at least two UEs that has been allocated with CCEs firstly and enhancing the transmitting power of the first other UE, and recalculating an UE-specific search space in every subframe of the first other UE according to the degraded CCE aggregation level; then reselecting and reallocating a group of CCEs for the first other UE in the subframe;
F1, reselecting and reallocating a group of CCEs for other UEs except the first other UE that have been allocated with CCEs;
G1, repeatedly executing Step A1 to D1 for the current UE.

23. The device according to claim 22, wherein the first processing element is also adapted for executing following steps in each subframe for the current UE:
H1, if a group of successive CCEs cannot be selected for the current UE at Step G1, skipping the current procedure of selecting CCEs in the current subframe for the current UE.

24. The device according to claim 16, wherein,
the selecting and allocating module is also adapted for, when the position determining module judges that at least one UE is in an center area within any cell of the at least two neighboring cells, for every UE of the at least one UE, according to a CCE aggregation level of the PDCCH for the current UE in the UE-specific search space of the PDCCH in each subframe of the current UE, selecting a group of CCEs without overlapping in frequency domain with a group of CCEs that have been allocated to PDCCHs for certain UEs, and allocating the group of CCEs to the PDCCH for the current UE; wherein the certain UEs comprise UEs at the edge of other cell neighboring the current cell and UEs within an overlapping area between the current cell and the other cells.

25. The device according to claim 24, wherein the selecting and allocating module comprises a second processing element, for executing A2 to E2 in each subframe for the current UE:
A2, for each subframe, to find a group of CCEs for the current UE in a preset mapping relationship table according to the PCI and CFI of the current UE and each the other UEs of the certain UEs that has been allocated with CCEs, and the group of CCEs finding above is overlapping in frequency domain with a group of CCEs that has been allocated to each the other UEs;
B2, for the current UE and for each subframe, excluding the group of CCEs that has been found at step A2 from the UE-specific search space of the current UE and then selecting a group of successive CCEs for the current UE in the remaining CCEs, where the UE-specific search space of the current UE is calculated according to the CCE aggregation level of the PDCCH of the current UE;
wherein in the mapping relationship table, there is corresponding relationship saved between a group of CCEs with serial numbers {(k−1)m˜km−1} in a cell with a CFI x and a PCI a, and a group of CCEs with serial numbers {A_{b,y,m}_{₁}_{^{k}}^{x},A_{b,y,m}_{₂}_{^{k}}^{x},A_{b,y,m}_{₃}_{^{k}}^{x}, . . . } in a cell with a CFI y and a PCI b, and the two group of CCEs overlap in frequency domain; 1≦x≦M and M represents a CFI maximum value, 0≦a≦N and N represents a PCI maximum value, k=1, 2, 3, . . . , m represents a preset granularity, y=1, 2, . . . , M, b=0, 1, . . . , N and b≠a, {A_{b,y,m}_{₁}_{^{k}}^{x},A_{b,y,m}_{₂}_{^{k}}^{x},A_{b,y,m}_{₃}_{^{k}}^{x}, . . . } represents serial numbers of a preset group of CCEs.

26. The device according to claim 25, wherein the second processing element is also adapted for executing following steps in each subframe for the current UE:
C2, for each subframe, if a group of successive CCEs cannot be selected for the current UE at step B2, excluding the UEs at the edge of other cell neighboring the current cell from certain UE and then executing step B2;
D2, for the current UE and for each subframe, excluding the group of CCEs that has been found at step C2 from the UE-specific search space of the current UE and then selecting a group of successive CCEs for the current UE in the remaining CCEs, where the UE-specific search space of the current UE is calculated according to the CCE aggregation level of the PDCCH of the current UE;

27. The device according to claim 26, wherein the second processing element is also adapted for executing following steps in each subframe to the current UE:
E2, if a group of successive CCEs cannot be selected for the current UE at step D2, selecting a group of successive CCEs randomly and decreasing a transmitting power of the current UE according to the CCE aggregation level of the PDCCH for the current UE in the UE-specific search space in the subframe.
